(19) United States
(12) Patent Application Publication
(10) Pub. No.: US 2011/0014842 A1
(43) Pub. Date: Jan. 20, 2011

(54) TOY AND METHOD DESIGNED TO ENHANCE EMOTIONAL LEARNING

(76) Inventor: NINA RAPPAPORT-ROWAN, SAN ANSELMO, CA (US)

Correspondence Address: STEVEN VOSEN, 1563 SOLANO AVENUE #206, BERKELEY, CA, 94707, US

(21) Appl. No.: 12/502,996

(22) Filed: Jul. 14, 2009

(51) Int. Cl. A63H 3/00; G09B 19/00

(52) U.S. Cl. 446/72; 434/236

(57) ABSTRACT

A plush toy for use in emotional learning is described herein. The plush toy can be used in conjunction with feeling pillows used to facilitate emotional learning. The plush toy embodiments include characters that can also be used in an online learning system used to teach emotional learning in a virtual world, which may exist, for example over the Internet or similar networking medium. The present invention further comprises methods of using a plush toy embodiment of the present invention as a means of facilitating emotional learning. These methods can be performed in the physical world with physical toy embodiments or in the virtual learning system with replicas of the physical toys.

### BACKGROUND OF THE INVENTION

The invention relates to plush toys and in particular to plush toys useful for assisting children, parents, educators, clinicians, and the like in facilitating the healthy emotional development of people of all ages. The plush toys of the present invention may be used in conjunction with a “feeling pillow.” The feeling pillow, or pillows, of the present invention are labeled in such a way so as to emulate human emotions. When used with a plush toy, the feeling pillow(s) can be used to help an individual express his or her feelings. If, for example, a child is using the plush toy, he or she may use a feeling pillow to communicate sadness, fear, happiness, or any of a variety of the human emotions each of us feels.

In addition, the invention relates to an Internet-enabled website, which has educational and social networking aspects. The plush toys are characters on the website and are used to enhance the emotional development of people of all ages.

The ability to express one's feelings in a healthy, constructive way is one of the hallmarks of living a healthy and happy life. Learning how to express feelings begins early in life, and is taught to children by parents, grandparents, teachers, coaches, camp counselors, psychologists, and within child play groups. Children learn emotional development through many modalities, one of which is playing with toys. Toys can be used by parents, teachers, and the like to facilitate teaching children how to express a wide range of feelings in an appropriate manner.

Raising healthy, happy children is also not done in isolation. Parents, teachers, clinicians, and generally most adults involved with raising, teaching, or caring for children rely on the advice of others who have raised, or are raising, children. It is common for parents to meet at soccer games and share the latest struggle they are facing with their 8 year-old who is having difficulty with a particular aspect of his life, perhaps sharing his toys with his younger sister. Parents, teachers and the like rely on the stories of others, what they found helpful for their child, and what was detrimental, as a resource for alternative approaches to child-rearing. In the situation where a child is having difficulty expressing his or her feelings, parents may seek advice from individuals external to the family to learn of different approaches for talking with or playing with a child. In this way, the parent endeavors to teach her child how to better express his or her feelings.

With the proliferation of social networking Internet sites, there has developed a need for parents and others with child-care responsibilities to be able to connect with each other and to share advice on how to help children learn how to express the wide range of human emotions we all have. This type of social networking site would be further helpful to parents if it was centered around a toy designed to aid in teaching children how to express themselves and the various emotions they may feel at any given time. In order for children to be actively involved in the learning process, the interactive website could be designed to capture the attention of a child. One way of doing this is to include characters on the website that emulate a toy or group of toys the child may already have. There is thus a need to couple traditional teaching mechanisms such as plush toys with a mechanism for expressing feelings for those plush toys with an interactive medium such as the Internet. In this way, parents can connect with many more resources than would be possible via traditional networking mechanisms.

### SUMMARY OF THE INVENTION

In one embodiment, the present invention is comprised of a first plush toy having at least one unique personality trait and a cavity used to place a second plush toy representing a “feeling” inside of the cavity. Within the present invention, there can be a variety of plush toys, and each of these plush toys could have personality traits distinct from the other plush toys. In addition, the “feelings” may be embodied in a small pillow with the feeling printed on the outside of the pillow. Feeling pillows of the present invention could cover a wide range of emotions. Additionally, a blank pillow could be used, wherein the user could write a unique feeling on that pillow.

In another embodiment of the present invention, a method of enhancing emotional learning is described utilizing the toy embodiments herein disclosed.

In an alternate embodiment, the present invention can be used in conjunction with an online interactive website, or learning system. The toy embodiments can be characters on the online learning system. This embodiment can be used by parents, teachers, clinicians, coaches, and the like for sharing information related to teaching and learning emotional expression. Children too, in this embodiment, can learn emotional skills by playing games, watching videos, or interacting with other children online. In an alternate embodiment, the online learning aspects of the invention can include a retail portion where parents, teachers, clinicians and the like can purchase additional learning materials, such as curricula or additional plush toys of the above-described embodiments.

### BRIEF DESCRIPTION OF THE DRAWINGS

FIG. 1 is an embodiment of a toy of the present invention.

FIG. 2 is an embodiment of a toy of the present invention.

FIG. 3 is an embodiment of a toy of the present invention.

FIG. 4 is an embodiment of a toy of the present invention.

FIG. 5 is an embodiment of a feeling pillows representing emotions according to the present invention.

FIG. 6 is an embodiment of a computer network used to host the online learning system of the present invention.

FIG. 7 is a homepage screen of the URL for the Kimochis website.

FIG. 8 is a sitemap of the online learning system.

### DETAILED DESCRIPTION OF THE PREFERRED EMBODIMENTS

Before the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is to be understood that the phraseology and terminology used herein is for the purpose of description and should not be regarded as limiting. The use of “including” and “comprising” and variations thereof herein is meant to encompass the items listed thereafter and equivalents thereof as well as additional items. The use of “consisting of” and variations thereof herein is meant to encompass only the items listed thereafter. The use of letters to identify steps of a method or process is simply for identification and is not meant to indicate that the steps should be performed in a particular order.

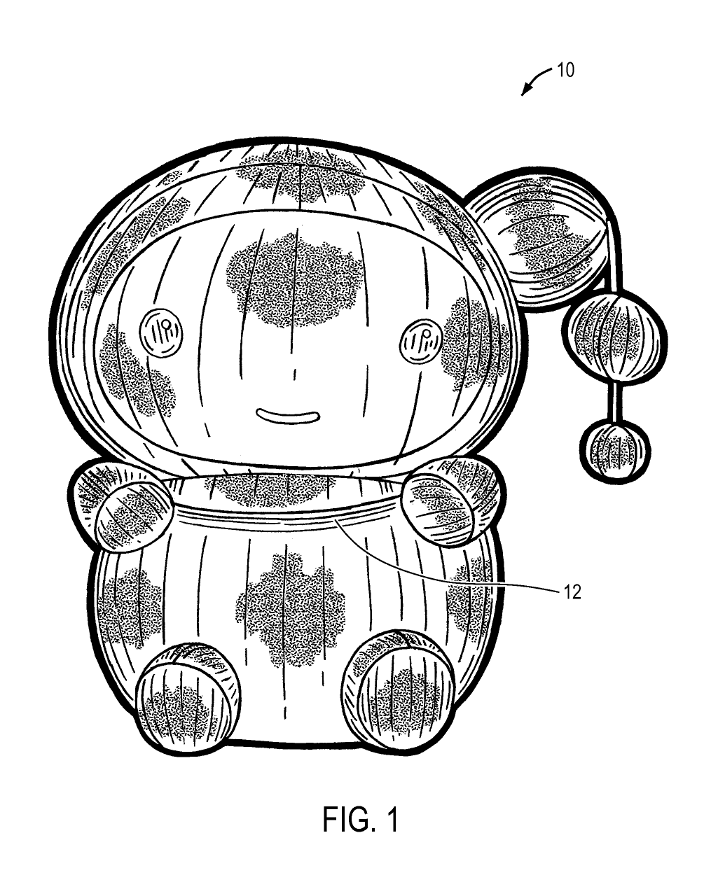

The present invention is first described in general and then more specifically under the section referring to FIGS. 1-8 sequentially. The first embodiments of the present invention include a plush toy or toy used in connection with plush toy depictions of feelings. These embodiments, as well as the other embodiments described later are primarily designed as teaching tools for children, adolescents, or even adults. The focus of the teaching is on emotional learning and expression. Although this specification refers primarily to using the present inventions to teach children, it should be understood that all human beings at any age can benefit from continued emotional learning. As such, any use of the term “child” as one who may use the present invention is not intended to be limited to an individual within any particular age group.

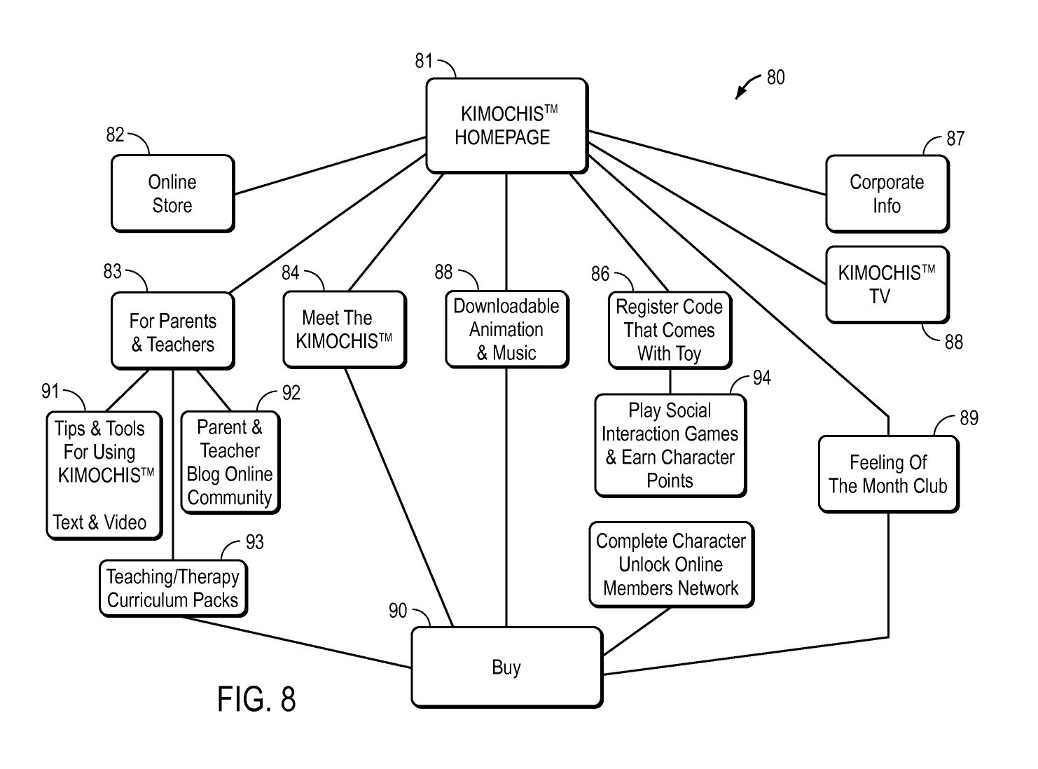

In other embodiments described herein, the present invention comprises a method of providing an Internet-based virtual learning environment. The method can further include providing access to an Internet-based game designed for facilitating emotional learning. Additional embodiments describe an Internet-based learning system again designed to facilitate emotional learning, which can optionally include the aforementioned game. To play the online game of the present invention, a child requires Internet access. Preferably, a child requires computer equipment including a computer hard drive, a display monitor, a keyboard, a device for selection, (such as, but not limited to, a mouse or a trackball or other pointing device to move a cursor to enable the child to select a link or menu option by “pointing to and clicking on” a selection on a screen display of the display monitor, or a touch screen, whereby the child merely selects a portion of the screen of the display monitor to select a link or a menu option) and a modem (or other access to the Internet) and speakers. Alternatively, the child may play the online game via a PDA, a mobile phone, an Internet appliance or another Internet enabled device. As shown in FIG. 8, which will be explained in detail later, the online game is accessed by the child via a URL for the website of the present invention. The game site operator may be an educational or corporate partner.

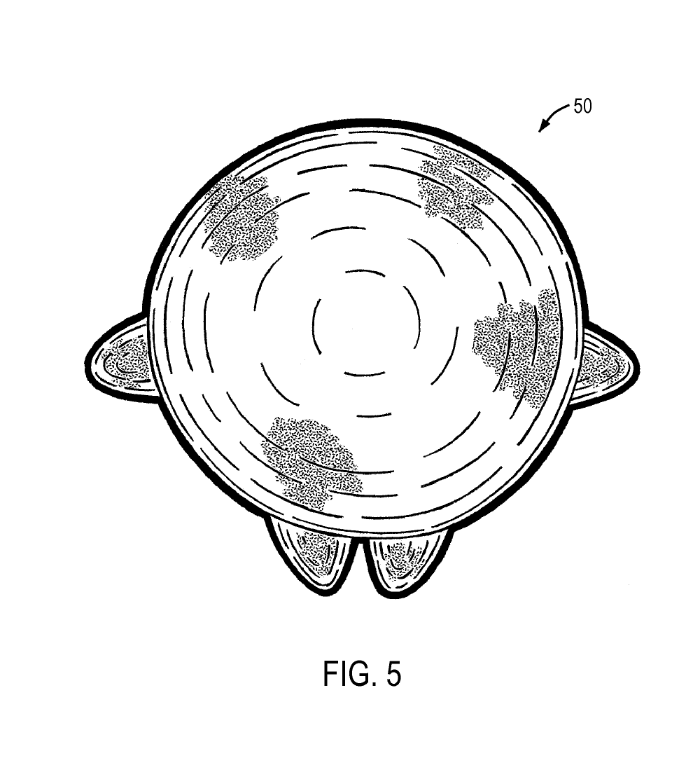

The toy embodiments, as depicted in FIGS. 1-4, may be used in a variety of settings including traditional, home-based play toy, as a clinical toy, as part of an educational curriculum, or as a cartoon-like replica via an Internet based social network or game. In one embodiment of the present invention, any of the toys of FIGS. 1-4 may have at least one unique personality trait and may be used in conjunction with a plush toy representing an emotion, also called a “feeling pillow” as shown in FIG. 5. In this way, a parent, clinician, or teacher can facilitate the healthy development of emotional expression within a child playing with the present invention.

FIG. 1 shows an embodiment of the present invention wherein the toy is a plush toy _____, optionally named “Cloud.” (referred to hereinafter as “Cloud.”). In this embodiment, the toy includes a cavity 12, wherein a feeling pillow can be placed. The toy 10 of this embodiment, with the cavity 12, can likewise be used in a method of teaching emotional expression. For example, a child may place one of the feeling pillows inside of Cloud's cavity. When interacting with a parent, teacher, other child, and so forth, the child's choice of which feeling pillow was placed inside of Cloud's cavity can be the starting point of a conversation related to the chosen feeling pillow. In this way, parents and others can begin a conversation related to that particular feeling pillow. Why is the child feeling that feeling? Does he remember feeling that way before? What helped him to feel better? Each of these, and many more, questions can easily flow when using the toy of this embodiment. Children will often speak more freely about their feelings when playing with an inanimate object, as is well known in the psychological arts.

In this embodiment, the toy 10 of FIG. 1, Cloud, may have a personality trait such as being unpredictable. The toy 10 may be happy one day, sad the next day, and then maybe happy again the following day. The toy 10 can optionally have a rotatable face, wherein one side of his face expresses his happy mood, and the other side represents his sad mood. The toy 10 can be used to help a child with a similar personality trait, or a child who is at a similar developmental stage, to learn to express and accept the wide range of human emotions we experience. Parents, children, teachers, or clinicians may choose to purchase Cloud because of his unpredictable personality.

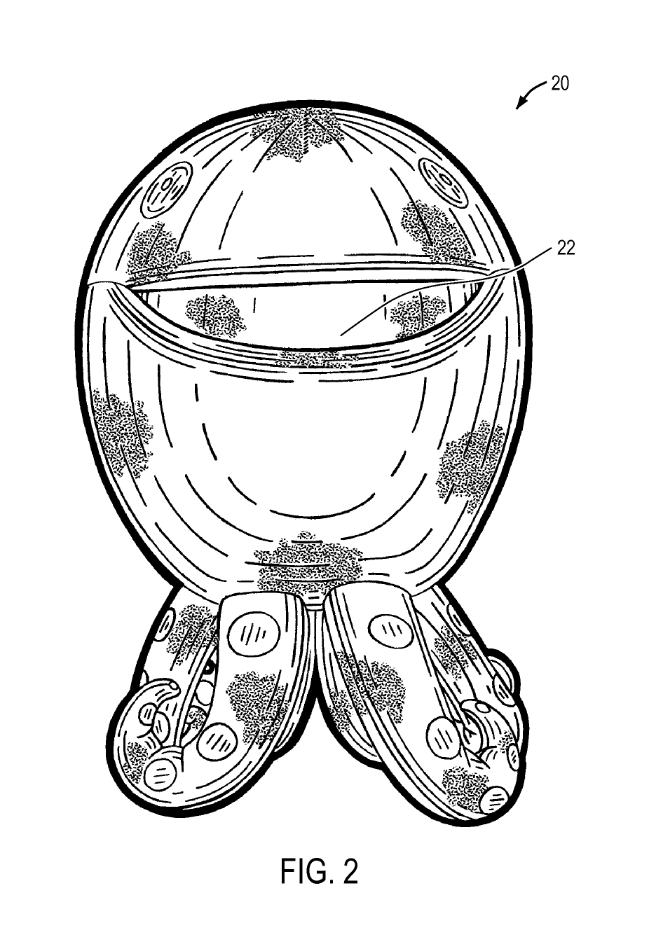

Turning to the embodiment of FIG. 2, the toy 20 includes a cavity 22. The toy 20 may optionally have different personality traits than those associated with the toy 10 of FIG. 1. The toy 20 of FIG. 2, optionally called “Huggtopus,” could, for example, be all smiles and hugs. The toy 20 may be very affectionate, and strong, and could sometimes get a little carried away by her big friendly personality. The toy 20 may not know her own strength and may sometimes be a little overbearing. The toy 20 may always mean well, but may be working on learning boundaries. An individual playing with the toy 20 may be able to count on her for trying to put a smile on your face and to give a hug when the individual is feeling down.

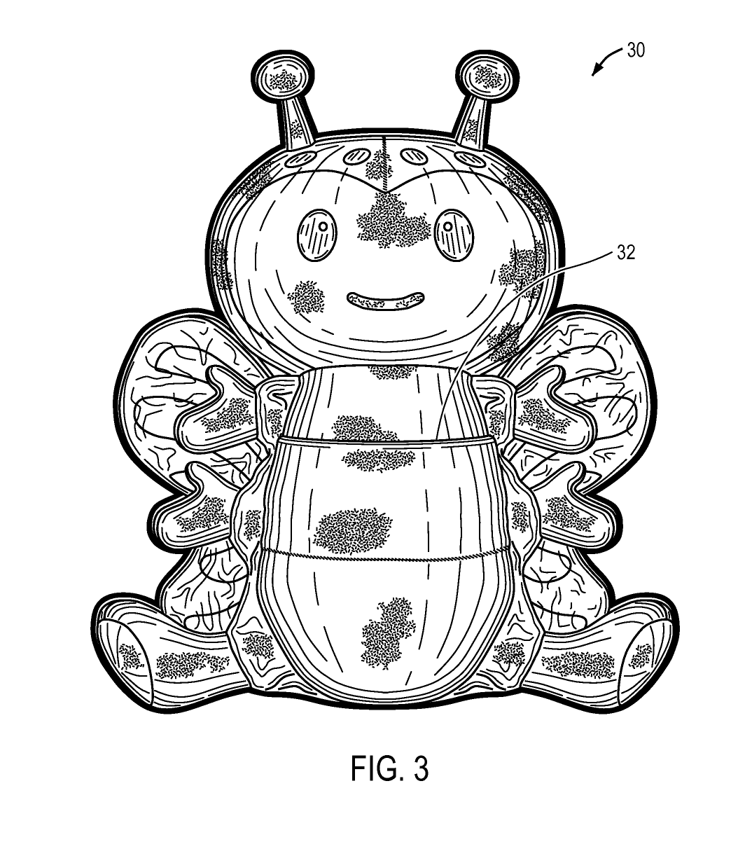

With regard to the embodiment of FIG. 3, the toy 30 includes a cavity 32. The toy 30 of FIG. 3 may have a personality trait of being thoughtful, and may optionally be called “Bug.”The toy 30 may also be cautious, or smart or a skilled conversationalist. In an additional embodiment, the toy 30 may be known to talk himself and others out of any given situation because he likes to examine all sides of an issue. In this embodiment, the toy may be known by his friends to be able to talk them out of doing just about anything because he may be able to talk so much that he gets his friends to forget what it was they were trying to accomplish. This toy 30 embodiment may also be afraid of change in an alternate embodiment. In this way, a child playing with the toy 30 may be able to address his or her own fear of change and learn how to express that fear in a healthy way. Because the toy 30 is depicted as Bug is a caterpillar, a user of the methods and embodiments described herein with recognize that it is particularly important for the toy 30 to confront his fear of change because change is an inevitable part of his life. In playing with the toy 30, a child, parent, teacher, or the like may use any of these personality traits as teaching tools with a child who is similarly afraid of change, or going through a period of change and struggling with how to cope with life changes.

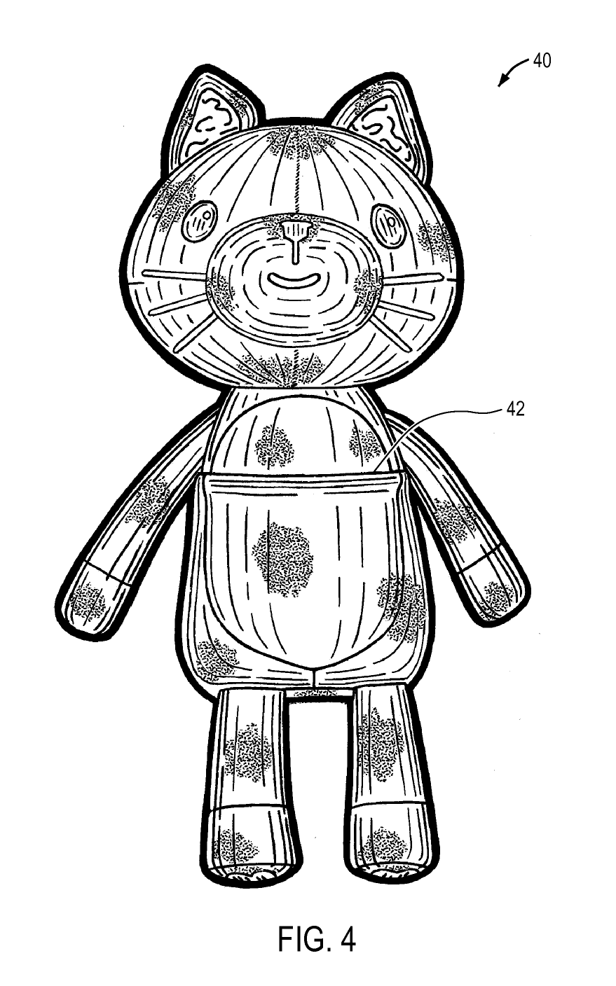

In the embodiment depicted in FIG. 4, the toy 40 includes a cavity 42. The toy 42, optionally called “Cat,” may have a personality trait of knowing what she wants. The toy 40 may also know when she wants it and why. The toy 40 may be a leader, but may sometimes be bossy. The toy 40 may have a favorite number of 10, and favorite color of purple, or love to snack on almond cookies or warm milk. The toy 40 may seem prickly on the outside, but she may also have a soft center.

The embodiments depicted in FIGS. 1-4 are exemplary. Similar embodiments are contemplated herein for toys having different shapes and animal likenesses. By way of example, the present invention could include a toy that is similar to a dove or a turtle. An elephant toy could be an additional embodiment, as could a frog. Design changes of this nature are contemplated herein and do not change the spirit and inventiveness of using a plush toy in connection with a feeling toy to enhance emotional learning.

Although the toys of FIGS. 1-4 are depicted as average size plush toys, it is to be understood that these toys could come in a variety of sizes and embodiments. For example, any of these embodiments may be miniaturized and added to a key chain so that a child could attach this version of the present invention to a backpack, bag, belt-loop or any number of places where fastening means would support a connection. Similarly, any of the embodiments of FIGS. 1-4 could be enlarged, or depicted as trading cards and used as educational tools as is well known in the art.

In one embodiment of the present invention, a feeling or emotion can be represented as a plush toy similar to that depicted in FIG. 5. As can be seen from FIG. 5, the present invention includes a second toy 50 representative of an emotion such as open, happy, alive, good, love, interested, positive, strong, angry, depressed, confused, helpless, indifferent, afraid, hurt, sad, affectionate, confident, engaged, inspired, excited, exhilarated, grateful, hopeful, joyful, peaceful, refreshed, annoyed, aversion, confused, disconnected, disquiet, embarrassed, fatigue, pain, sad, tense, vulnerable, or yearning. One skilled in the art will recognize that these feelings have many sub-categories, and different words could be chosen to represent these feelings and any of the sub-categories of feelings. It would be impractical to provide a complete list of all human emotions. This list is, therefore, intended to be exemplary and not exhaustive.

The toy 50 can be used in connection with any of the toys 10, 20, 30, or 40 or other toy embodiments disclosed herein to facilitate emotional learning. Using the toy 10 of FIG. 1, as an illustrative example, the cavity 12 can be used as a location for a child or adult to place a “feeling pillow.” Once the feeling pillow is placed inside the cavity 12 of the toy 10, those engaging with the toy can discuss the feeling. The toy 10 and the feeling 50 can be used to facilitate learning in a method embodiment of the present invention.

In this embodiment, an educator or parent could ask a child to choose a feeling 50 and place it inside of the cavity 12. The two could then talk about the transitory nature of feelings, or discuss coping strategies for a particular feeling. Moreover, in conjunction with the personality traits associated with the various embodiments of the toys 10, 20, 30, 40, a feeling 50 may have a different connotation depending upon the personality trait of the toy 10, 20, 30, 40 with which that feeling 50 is used. For example, if the toy 10 with a personality trait of unpredictability is experience a feeling 50, it may have a connotation different than if a toy 20 who is typically all smiles and hugs has the same feeling 50. In the miniaturized, enlarged, or trading card versions of the present invention, the feelings 70 of these embodiments could similarly change size in proportion to the size of the plush toy embodiments, or could be depicted on trading cards and used in game play thusly.

In a classroom setting, any of the aforementioned toy embodiments of the present invention could be used by a classroom instructor. The instructor may, for example, have a play period where a student uses a toy 10, 20, 30, 40 of the present invention to place a feeling 50 he or she is having inside of the cavity 12, 22, 32, 42 of any of the toy embodiments. Once the feeling 50 has been placed inside of the cavity 12, 22, 32, 42, the instructor could use the toy 10, 20, 30, 40 of the present invention to discuss the particular feeling 50 as a classroom learning experience. Similarly, the instructor may want to teach by example and use an embodiment of the present invention to place a feeling 50 he or she is having inside the cavity 12, 22, 32, 42 of a toy 10, 20, 30, 40. In that way, the instructor could initiate a discussion of a selected feeling 50. Moreover, the instructor could discuss how adults have similar feelings as children and segue from there into coping mechanisms adults use for emotional balancing.

In an online embodiment of the present invention, the inventive concepts could be used in an online game or as part of a virtual world designed to further the emotional development of those participating online. In an online embodiment, the game and virtual world are implemented using an interactive website via a user computer connected to the Internet. In this way, the user can play with a virtual representation of his or her toy in a virtual world. Play in the virtual world is designed to further bolster the emotional development of the user. Moreover, the learning associated with playing with any of the toy 10, 20, 30, 40 embodiments could be propagated to a larger audience via the Internet. For example, an online community could exchange email communications, blog postings, video or pictures centered on the learning and emotional growth associated with playing with the plush toys described above.

The current embodiment can utilize the Internet as a public communications network. However, other communication networks could be utilized, such as telephone networks, cellular networks, local area networks, dedicated networks, a private computer network, cable television networks, satellite networks, and the like. By way of example, the online aspects of the current invention could be included within an application run on a cellular telephone via a cellular network. Similarly, the online aspects could be run on a local area network in a school, clinic, or retail setting.

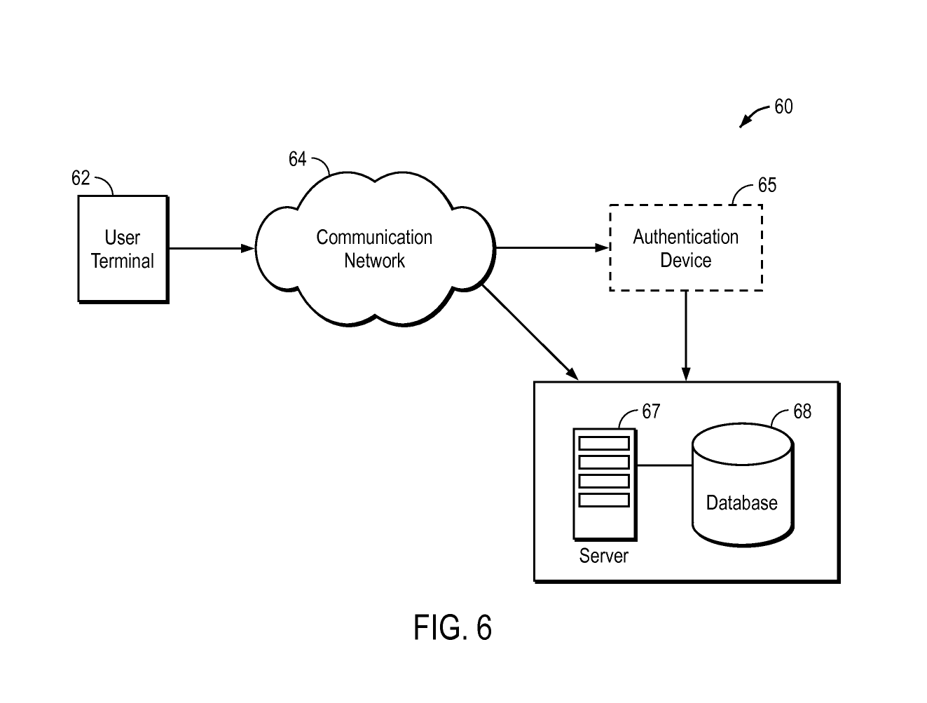

FIG. 6 shows an embodiment of computer network that could be used to host the online learning system 60 of the present invention. In this embodiment, users of the learning system can access a website, optionally located at the URL, www.kimochis.com, “the Kimochis website” via a user terminal 62 and a communications network 64, as is well known in the art. The Kimochis website can be hosted on a server 67 coupled to a database 68, as is also well known in the art. Optionally, some portions of the Kimochis website may not be generally accessible by the public and may require entering a registration code or some other type of authentication. Access to this portion of the Kimochis website could be controlled by an authentication device 65, as is well known in the art. Authentication could be performed by a router, gateway, software authentication means, or the like.

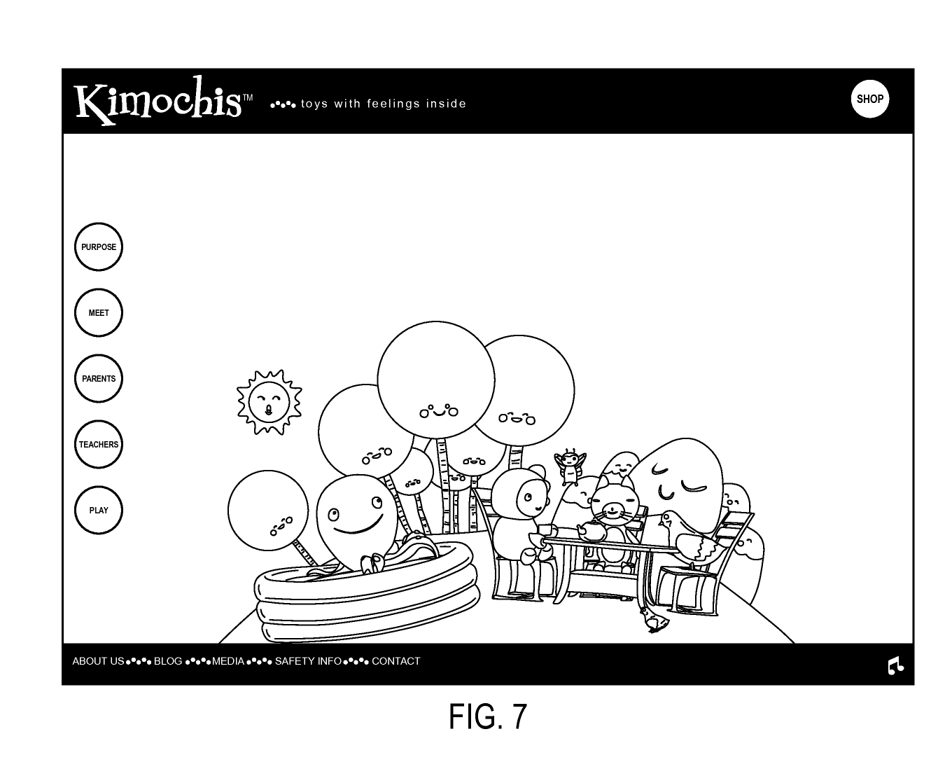

To access the online game of the present invention, the child enters the URL of the game site of the present invention into the web browser. Once the URL of the game site has been entered, the child enters the Kimochis website and a homepage screen, as is shown in FIG. 7, is displayed on the display monitor. The homepage display screen 70 has a number of links 72, shown more fully in the sitemap of FIG. 8. The home page screen 70 bears the URL of the online game site, depicted as www.kimochis.com in FIG. 7. A child using the present invention can access any of the links 72, typically by pointing and clicking on the linkage to enter a particular link. Once a child accesses a link, he or she can learn more information about the educational toys of the present invention.

FIG. 8 shows a top-level block diagram, or sitemap, of an online learning system 60 for an embodiment of the present invention. In this embodiment, the learning system 60 is comprised of a server 67 for interacting with users via a computer being operated by the user. In this embodiment, the online site map used in conjunction with the plush toys and feelings pillows includes the following features: a homepage 81, an online store 82, a section for parents and teachers 83, meet the characters 84 downloadable animation and music 85, a register codes aspect 86, corporate information 87, a television link 88, a feeling of the month club 89, and an online store 90.

Turning first to the homepage 81, the homepage 81, includes animated pictures of some of the character embodiments described herein. For example, the homepage 81, includes representations of Cloud, Huggtopus, Bug, and Cat. In the online learning system of the present invention 60, users can access more information about each of the Kimochis in the meet the characters 84 portion of the Kimochis website.

In terms of fostering emotional learning in children or users of the online learning system 60, the Kimochis characters have individualized personality traits. These traits can be used as teaching tools, when a user accesses the online learning system 60. Several links within the online learning system 60 provide users with opportunities to facilitate emotional learning. By way of example, the online learning system 60 includes a collection of information for parents and teachers 83. This portion of the online learning system 60 may include tips and tools for using Kimochis to facilitate emotional learning. There may also be text or videos 91 designed to allow users to gain greater knowledge about facilitating emotional learning. In an additional embodiment, there could be a blog or online community 92 where parents or teachers could share information about children and their emotional learning.

The online learning system 60 may also include downloadable animation or music 85. In an alternate embodiment, users could upload movies of their experiences using Kimochis into the a television link 88, which is a portion of the online learning system 60 optionally called Kimochis TV. The online learning system 60 may also include portions where users can make purchases via an online store 90. In this embodiment, users may be able to purchase toys 10, 20, 30, 40, or alternate embodiments of toys. Users could also purchase via the online store 90 feelings 50, or teaching or clinical curriculum packages 93. Users may alternatively be able to purchase music or movies 85 via the online store 90. Moreover, users could play social interaction games 94, whereby, for example, character information could be unlocked as users progress through the game. These embodiments could be free to users. They may also require optionally a user registration process entailing either proof of purchase of Kimochi products or a pay-as-you-go mechanism as is well known in the online retail arts.

In an online embodiment of the present invention, Cloud, the toy 10 of FIG. 1 could live in the sky and love to travel across treetops paying visits to all of his friends. When the toy 10 is happy in this embodiment, he may spread sunshine across the online universe. In this embodiment, Cloud's happiness, when spread throughout the online universe, may increase the happiness of other online toys. Similarly, when Cloud is unhappy in an online embodiment, his unhappiness may spread to other online toys. In this way, children using the online embodiment of the present invention could learn how their feelings affect others. In an alternate embodiment, Cloud may have a hard time controlling his emotions, just as many young children may have a hard time controlling their emotions. It is the similarity between Cloud and a child that a parent, teacher, clinician, or the like could use as a teaching point to help the child accept that emotions can come on quickly and pass quickly and that the healthy expression of emotion involves constructively expressing the emotion.

In an online embodiment of the toy 20 depicted in FIG. 2, Huggtopus, may live in a swimming hole. Her favorite number could be 8, and her favorite color could be pink. This embodiment may also love to eat everything, but bubble gum may be her very favorite food. In addition, she could in this online embodiment play a musical instrument such as the xylophone.

In the online learning system of the present invention, the toy 30 of FIG. 3, Bug, could live in a Manzanita tree and could also have a swimming hole. Bug's swimming hole could have a tethered rope swing located in his living room. The swimming hole might be a central location in the online version where the various toys congregate. The toy 30 of FIG. 3 may play a musical instrument, by way of example, the mandolin. He may have a lucky number—2, and a favorite color—magenta. In additional embodiments, this toy 30 may love the smell of rosemary and the taste of wild honey. As was discussed with respect to the physical toy of this embodiment, the online version of toy 30 could also be afraid of change, which is particularly challenging for this toy because he will inevitably change into a butterfly. In the online embodiment, toy 30 may secretly dream of flying. In addition, the online version of toy 30 could love to read maps and could have a great sense of direction.

In an online learning system of the present invention, the toy 40 of FIG. 4, Cat, could live in a cherry blossom tree. In an alternate embodiment, she may like to keep her home tidy. She may also, optionally, enjoy hosting tea parties. In alternate embodiments of the present invention, additional toys could be rendered on the virtual learning environment.

The virtual learning environment could, in alternate embodiments include a game designed to engage children of a young age. The purpose of the game could be as simple as teaching a child the benefits of expressing feelings by awarding points when a rendition of a toy of the present invention “captures” or virtually expresses a feeling. Similarly, points could be deducted in the online game if the rendition of the toy does not express a feeling, but instead acts out. The game in alternate embodiments could incorporate more complex expressions of feelings, where an online user may be asked to associate a feeling with a particular experience the rendition of the toy is having during game play in the virtual learning environment. The choice of feeling could affect game play and lead to different variations within the game depending on the feeling chosen.

The learning system of the present invention could be used to facilitate emotional learning. In this embodiment, a user could access the online learning system 60. The user could then chose a character from the available representations of toys 10, 20, 30, 40, or other embodiments. Once the user chooses a character, he or she could choose a feeling 50 for that character.

In an online version of the present invention, participants may similarly place a feeling 50 within the cavity 12, 22, 32, 42 of the virtual representation of any of the toy 10, 20, 30, 40 embodiments described herein. Placing a feeling 50 inside the online representation of a toy 10, 20, 30, 40 could have a variety of effects. As an example, if a happy feeling was placed inside of Cloud's cavity, it may increase the happiness of the other toys then present in the online version of the this embodiment. In this way, a child or other individual learning through play with the present invention could learn how his or her feelings and expressions of feelings can have an impact on others. As another example of how the present invention can be used to teach how feelings affect those external to us, an online user could place the feeling “shy” inside of the toy's cavity. In one embodiment, placing “shy” inside of Bug's cavity, could prompt some of the other online toys to approach the toy feeling shy and introduce themselves. They may ask the shy feeling toy if it would like to play.

What I claim is:

1. A toy used for exploring an emotional experience comprising:
a. a first plush toy, wherein the plush toy has a cavity with a corresponding opening allowing access to the cavity;
b. the first plush toy having at least a personality trait associated with it; and,
c. a second plush toy representative of an emotion, wherein the second plush toy can be inserted into the cavity as part of an emotional learning experience.

2. The toy of claim 1 further comprising a rotatable head with two different faces on each side.

3. The toy of claim 2 wherein a first side of the rotatable head has a happy face.

4. The toy of claim 3 wherein a second side of the rotatable head has a sad face.

5. The toy of claim 1 wherein the second plush toy representative of an emotion is labeled a word chosen from the group consisting of: happy, sad, mad, silly, frustrated, brave, left-out, shy, grateful, jealous, scared, shy, curious, sleepy, surprised, embarrassed, guilty, excited, kind, hurt, sorry, uncomfortable, or friendly.

6. The toy of claim 5 wherein the emotions are different colors.

7. A method of using a first plush toy to facilitate emotional learning comprising the steps of:
a. Placing a second plush toy representing an emotion inside of a cavity within the first plush toy, wherein the second plush toy is labeled with a word chosen from the group consisting of: happy, sad, mad, silly, frustrated, brave, left-out, shy, grateful, jealous, scared, shy, curious, sleepy, surprised, embarrassed, guilty, excited, kind, hurt, sorry, uncomfortable, or friendly.

8. A method of providing a virtual learning environment for use as a learning platform related to emotional development comprising the steps of:
a. Providing an Internet-based virtual environment; and
b. Allowing access to the Internet-based learning environment, wherein the Internet-based virtual environment comprises:
i. a representation of at least one first plush toy; and
ii. a representation of at least a second plush toy, wherein the at least a second plush toy is representative of a human emotion.

9. The method of claim 8 wherein the Internet-based virtual environment further comprises an interactive game.

10. An learning system for teaching emotional development to an individual comprising:
a. A user terminal with means for accessing a communication network;
b. A communication network;
c. A server coupled to a database used for storing data that facilitates an online learning experience related to learning emotional development skills by using representations of at least a first plush toy and a representation of at least one feeling.

11. The learning system of claim 9 further comprising registration means for allowing access to the server and database.

12. The learning system of claim 10 wherein the registration means is used to allow access to a portion of the server and database.
